(19) United States
(12) Patent Application Publication
(10) Pub. No.: US 2006/0270472 A1
(43) Pub. Date: Nov. 30, 2006

(54) Mobile communication devices

(75) Inventors: Yung Jinn Chen, Taipei (TW); Cheng Kuo Wang, Taipei (TW)

Correspondence Address: QUINTERO LAW OFFICE, 1617 BROADWAY, 3RD FLOOR, SANTA MONICA, CA, 90404, US

(73) Assignee: WISTRON NEWEB CORP., TAIPEI HSIEN (TW)

(21) Appl. No.: 11/228,848

(22) Filed: Sep. 15, 2005

(30) Foreign Application Priority Data
May 26, 2005 (TW) TW94117228

(51) Int. Cl. H04M 1/00

(52) U.S. Cl. 455/575.7

(57) ABSTRACT

Mobile communication devices are provided. A mobile communication device includes a planar antenna, an input unit and a display unit pivotally connected to the input unit. The display unit includes a first casing having a first outer surface. The planar antenna includes a conductive element exposed on the first outer surface.

### BACKGROUND

The invention relates in general to mobile communication devices and in particular to mobile communication devices with planar antennas.

Embedded antennas, such as chip antennas and planar antennas, are widely applied in wireless communication devices. A conventional type is a ceramic chip antenna produced by LTCC (Low Temperature Co-fired Ceramic) technology. Conventional planar antennas such as microstrip antennas, printed antennas and Planar Inverted F Antennas (PIFAs), are generally applied in GSM, DCS, UMTS, WLAN, and bluetooth wireless equipment such as mobile phones and wireless LAN adapters.

Referring to FIG. 1, a conventional mobile communication device, such as a collapsible mobile phone, primarily comprises a display unit 10 and an input unit 20. The input unit 20, such as a keyboard or touch pad, is pivotally connected to the display unit 10 via a hinge H.

As shown in FIG. 1, an antenna is alternatively disposed in a position A of the input unit 20 or a position A′ of the display unit 10. When holding the input unit 20 with the antenna in position A, the antenna may be covered by hands, adversely affecting communication efficiency thereof. Moreover, since the battery B and other electronic components occupy much space within the input unit 20, it may be difficult to arrange the antenna.

The antenna can also be disposed in position A′ of the display unit 10, to avoid being blocked. However, as the main display (not shown) and sub display S1 occupy much space within the display unit 10, it is also difficult to arrange the antenna.

### SUMMARY

Mobile communication devices are provided. An embodiment of a mobile communication device includes a planar antenna, an input unit and a display unit pivotally connected to the input unit. The display unit includes a first casing having a first outer surface. The planar antenna includes a conductive element exposed on the first outer surface.

The present invention further provides a mobile communication device including an input unit, a planar antenna and a display unit pivotally connected to the input unit. The display unit comprises a first casing and a second casing adjacent to the first casing. The first casing comprises a first outer surface. The second casing comprises a second outer surface rotating toward the input unit when collapsing the display unit and the input unit. The planar antenna comprises a conductive element exposed on the second outer surface.

### DESCRIPTION OF THE DRAWINGS

FIG. 1 is a perspective diagram of a conventional mobile communication device;

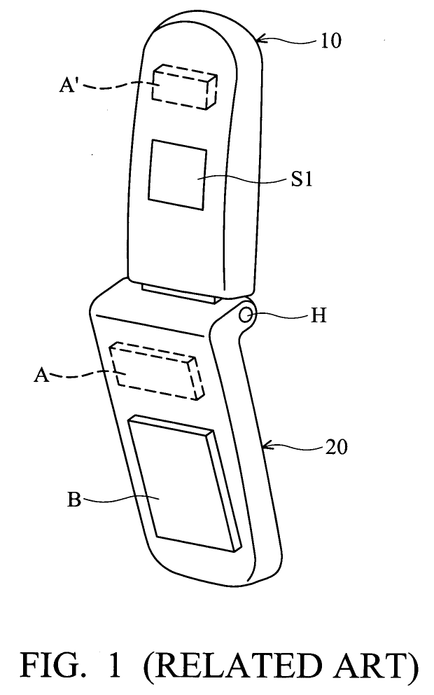

FIG. 2A is a perspective diagram of an embodiment of a mobile communication device;

FIG. 2B is a perspective diagram of an embodiment of a mobile communication device;

FIG. 3 is a perspective diagram of an embodiment of a mobile communication device;

FIG. 4 is a perspective diagram of an embodiment of a mobile communication device;

FIG. 5 is a perspective diagram of an embodiment of a mobile communication device;

FIG. 6 is a perspective diagram of an embodiment of a mobile communication device; and

FIG. 7 is a perspective diagram of an embodiment of a mobile communication device.

### DETAILED DESCRIPTION

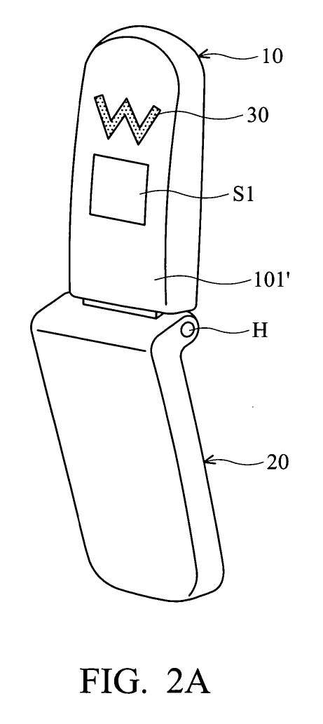

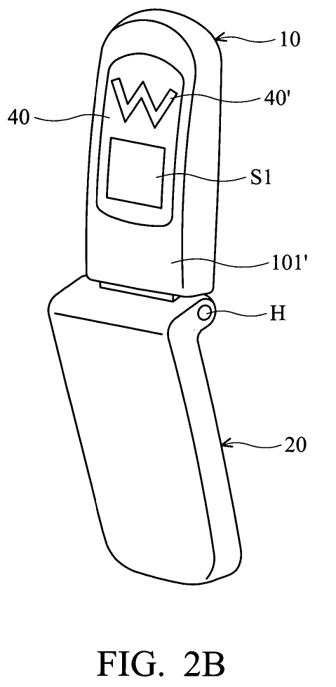

Referring to FIG. 2A, an embodiment of a mobile communication device, such as a collapsible mobile phone, PDA or GPS device, primarily comprises a display unit 10 and an input unit 20 pivotally connected via a hinge H. The display unit 10 has a first outer surface 101′ with a sub display S1 and a conductive element of a planar antenna 30 disposed thereon. In some embodiments, the planar antenna 30 can be a patch antenna with the conductive element exposed on the first outer surface 101′, forming a specific pattern. The conductive element can also form at least a part of an identification mark or designed appearance on the mobile communication device.

With the conductive element of the planar antenna 30 exposed on the first outer surface 101′ of the display unit 10, free from blockage, communication efficiency is potentially improved. Moreover, since the conductive element of the planar antenna 30 can constitute at least a part of an identification mark or designed appearance on the mobile communication device, cost of production is also potentially reduced.

With respect to FIG. 2B, another embodiment of a planar antenna 40 is a slot type antenna with the conductive element exposed on the first outer surface 101′ of the display unit 10. Specifically, the conductive element of the planar antenna 40 has a slot 40′ at the center thereof, forming a specific pattern. In some embodiments, the conductive element can also form at least a part of an identification mark or designed appearance on the mobile communication device.

With the conductive element of the planar antenna 40 exposed on the first outer surface 101′, free from blockage, communication efficiency is potentially improved. Moreover, since the slot 40′ of the planar antenna 40 can constitute at least a part of an identification mark or designed appearance on the mobile communication device, cost of production is also potentially reduced.

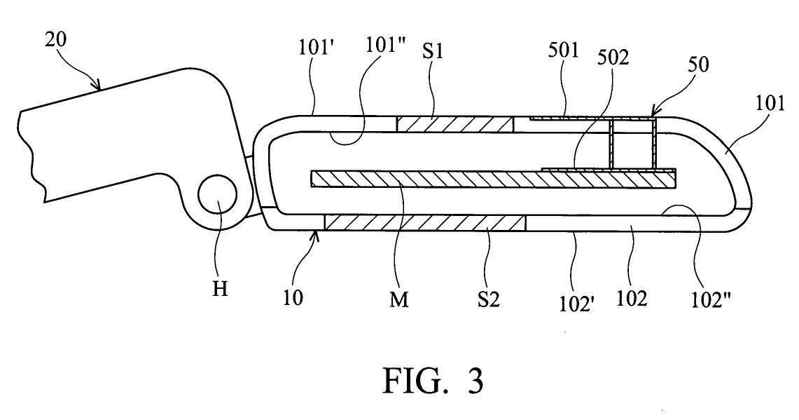

As shown in FIG. 3, another embodiment of a mobile communication device comprises a display unit 10 and an input unit 20 pivotally connected via a hinge H. The display unit 10 comprises a first casing 101, a second casing 102, a planar antenna 50, a printed circuit board M, a main display S2 and a sub display S1. The planar antenna 50, such as a Planar Inverted F Antenna (PIFA), comprises a ground 502 disposed on the printed circuit board M and a conductive element 501 exposed on the first outer surface 101′ of the first casing 101. The ground 502 can be metal, and the printed circuit board M is disposed in the display unit 10, comprising a display drive circuit to drive and control the main display S2 and the sub display S1.

As the conductive element 501 is exposed on the first outer surface 101′ of the first casing 101, free from blockage, communication efficiency is potentially improved. Moreover, since the conductive element 501 can constitute at least a part of an identification mark or designed appearance on the mobile communication device, cost of production is also potentially reduced.

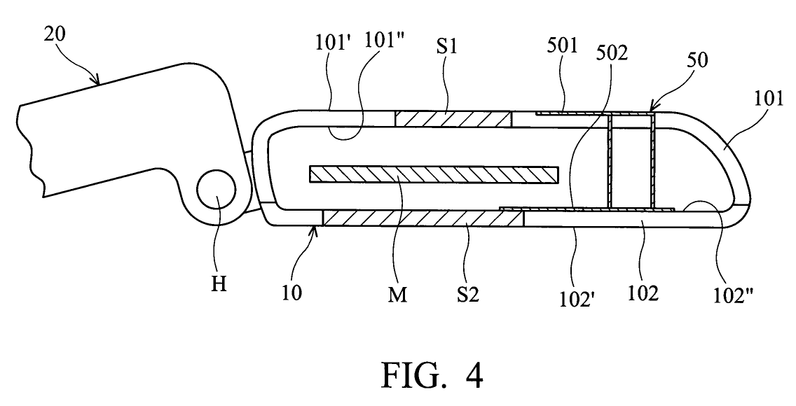

Referring to FIG. 4, another embodiment of the conductive element 501 is exposed on the first outer surface 101′ of the first casing 101, and the ground 502 is mounted on a second inner surface 102″ of the second casing 102, substantially parallel to the first outer surface 101′. In some embodiments, the ground 502 can be a metal or conductive coating of the second inner surface 102″. As the ground 502 is separated a specific distance from the conductive element 501, communication efficiency is potentially improved.

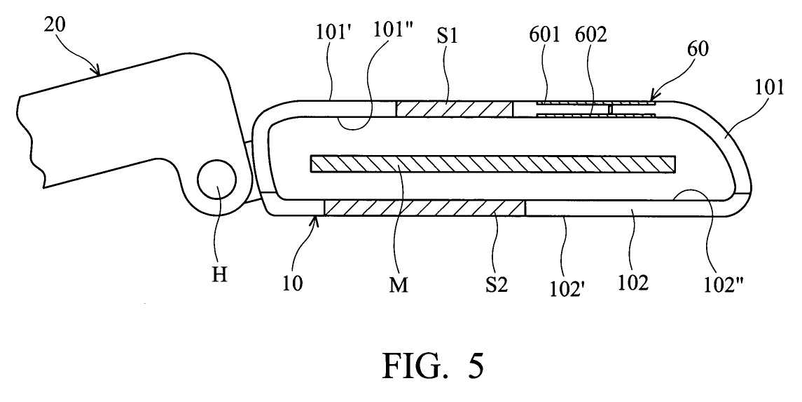

In FIG. 5, another embodiment of a display unit 10 comprises a planar antenna 60, such as a patch antenna. The planar antenna 60 comprises a conductive element 601 and a ground 602 both mounted on the first casing 101. As shown in FIG. 5, the conductive element 601 is exposed on the first outer surface 101′, and the ground 602 is mounted on the first inner surface 101″ of the first casing 101. In the present embodiment, the ground 602 is metal or conductive coating.

As the conductive element 601 is exposed on the first outer surface 101′ free from blockage, communication efficiency is potentially improved. Moreover, since the conductive element 601 can constitute at least a part of an identification mark or designed appearance on the mobile communication device, cost of production is also potentially reduced.

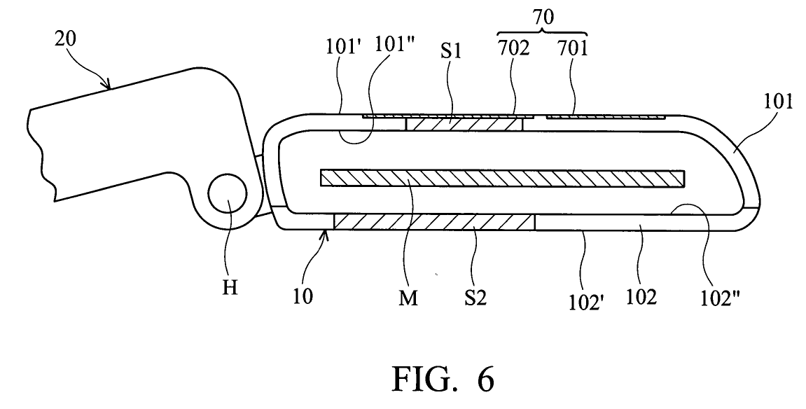

Referring to FIG. 6, a planar antenna 70, such as a planar monopole antenna, is mounted on the first outer surface 101′ of the first casing 101, comprising a conductive element 701 and a ground 702 both exposed on the first outer surface 101′. As the conductive element 701 is exposed on the first outer surface 101′ free from blockage, communication efficiency is potentially improved. Moreover, as the conductive element 701 or the ground 702 can constitute at least a part of an identification mark or designed appearance on the mobile communication device, cost of production is also potentially reduced.

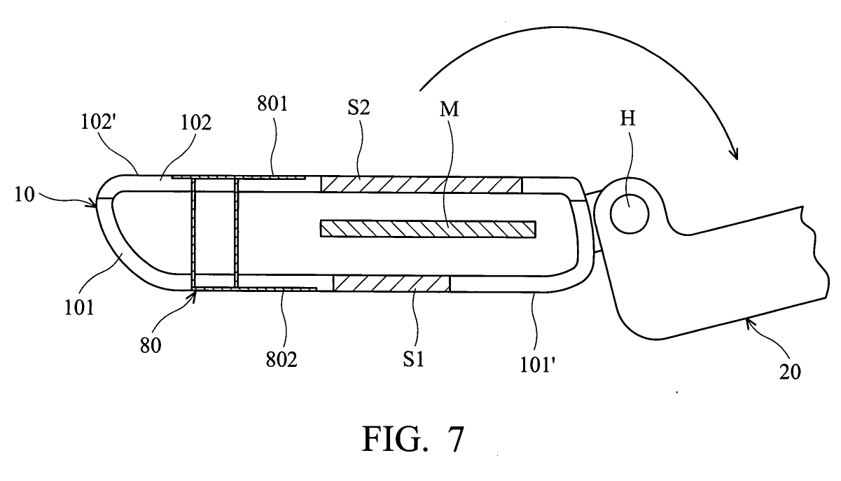

With respect to FIG. 7, another embodiment of a mobile communication device, such as a collapsible GPS device, primarily comprises a display 10 and an input unit 20 pivotally connected via a hinge H. The display unit 10 comprises a first casing 101, a second casing 102, a planar antenna 80, a printed circuit board M, a main display S2 and a sub display S1. As shown in FIG. 7, the first casing 101 is located on the outer side of the display unit 10, comprising a first outer surface 101′, and the second casing 102 comprises a second outer surface 102′ adjacent to the first outer surface 101′. When collapsing the display unit 10 and the input unit 20, the first casing 101 faces outward, and the second outer surface 102′ rotates toward the input unit 20, as the arrow shows in FIG. 7.

The planar antenna 80, such as a Planar Inverted F Antenna (PIFA), comprises a conductive element 801 exposed on the second outer surface 102′ of the second casing 102 and a ground 802 exposed on the first outer surface 101′ of the first casing 101. As the ground 802 is separated a specific distance from the conductive element 801, communication efficiency of the antenna 80 is potentially improved.

In some embodiments, the ground 802 can also be disposed on the printed circuit board M. In some embodiments, both the conductive element 801 and the ground 802 are mounted on the second casing 102, as a patch antenna. In some embodiments, both the conductive element 801 and the ground 802 are exposed on the second outer surface 102′ of the second casing 102, as a planar monopole antenna.

With respect to some communication devices, especially the GPS devices, both the main display S2 and the antenna 80 have to be activated during use, wherein the antenna 80 is oriented toward a specific direction for communicating radio signals. As shown in FIG. 7, since the conductive element 801 is exposed on the second surface 102′ of the second casing 102, facing upward and free from blockage, communication efficiency is potentially improved. Moreover, as the conductive element 801 can constitute at least a part of an identification mark or designed appearance on the mobile communication device, cost of production is also potentially reduced.

The planar antennas can be applied in low bandwidth or multi bandwidth systems. In some embodiments, the planar antennas can be used as an AUX antenna to compensate radiation field pattern and antenna gain of some specific locations, potentially broadening the bandwidth thereof.

Mobile communication devices are provided according to the embodiments. Since the conductive element of the antenna is exposed on an outer surface, increasing radiation area and free from blockage, communication efficiency is potentially improved. Moreover, as the conductive element constitutes at least a part of an identification mark or designed appearance on the mobile communication device, cost of production is also potentially reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A mobile communication device, comprising:
an input unit;
a display unit pivotally connected to the input unit, wherein the display unit comprises a first casing, and the first casing has an outer surface; and
a planar antenna, comprising a conductive element exposed on the outer surface.

2. The mobile communication device as claimed in claim 1, further comprising a pattern exposed on the outer surface, wherein the conductive element constitutes at least a part of the pattern.

3. The mobile communication device as claimed in claim 1, further comprising a hinge pivotally connecting the input unit and the display unit.

4. The mobile communication device as claimed in claim 1, wherein the planar antenna further comprises a ground connected to the first casing.

5. The mobile communication device as claimed in claim 4, wherein the first casing further comprises a first inner surface, and the ground is a metal or a conductive coating on the first inner surface.

6. The mobile communication device as claimed in claim 1, wherein the planar antenna is a patch antenna.

7. The mobile communication device as claimed in claim 1, wherein the planar antenna is a slot type antenna.

8. The mobile communication device as claimed in claim 1, wherein the display unit further comprises a printed circuit board, and the planar antenna further comprises a ground disposed on the printed circuit board.

9. The mobile communication device as claimed in claim 8, wherein the ground is metal.

10. The mobile communication device as claimed in claim 8, wherein the display unit further comprises a main display, and the printed circuit board comprises a display drive circuit to drive and control the main display.

11. The mobile communication device as claimed in claim 8, wherein the display unit further comprises a sub display disposed on the first casing, and the printed circuit board comprises a display drive circuit to drive and control the sub display.

12. The mobile communication device as claimed in claim 1, wherein the display unit further comprises a second casing connected to the first casing, and the planar antenna further comprises a ground connected to the second casing, separated from the conductive element.

13. The mobile communication device as claimed in claim 12, wherein the second casing comprises a second inner surface substantially parallel to the first outer surface, and the ground is a metal or a conductive coating on the second inner surface.

14. The mobile communication device as claimed in claim 1, wherein the planar antenna is a planar inverted F antenna (PIFA).

15. The mobile communication device as claimed in claim 1, wherein the planar antenna further comprises a ground exposed on the first outer surface.

16. The mobile communication device as claimed in claim 15, further comprising a pattern exposed on the first outer surface, and the ground constitutes at least a part of the pattern.

17. The mobile communication device as claimed in claim 1, wherein the planar antenna is a planar monopole antenna.

18. A mobile communication device, comprising:
an input unit;
a display unit pivotally connected to the input unit, comprising a first casing and a second casing adjacent to the first casing, wherein the first casing comprises a first outer surface, and the second casing comprises a second outer surface rotating toward the input unit when collapsing the display unit and the input unit; and
a planar antenna, comprising a conductive element exposed on the second outer surface.

19. The mobile communication device as claimed in claim 18, wherein the planar antenna further comprises a ground, and the ground is mounted on the first casing and exposed on the first outer surface.

20. The mobile communication device as claimed in claim 18, wherein the mobile communication device is a GPS device.
